(19) United States
(12) Patent Application Publication
(10) Pub. No.: US 2008/0159873 A1
(43) Pub. Date: Jul. 3, 2008

(54) CROSS FLUID-FLOW AXIS TURBINE

(75) Inventor: Phi Tran, Cypress, TX (US)

Correspondence Address: VERMETTE & CO., SUITE 320 - 1177 WEST HASTINGS STREET, VANCOUVER, BC, V6E2K3, omitted

(73) Assignee: NEO-Aerodynamic Ltd., Cypress, TX (US)

(21) Appl. No.: 11/947,709

(22) Filed: Nov. 29, 2007

Related U.S. Application Data
(60) Provisional application No. 60/872,679, filed on Dec. 5, 2006.

(51) Int. Cl. F03D 3/00; F03B 7/00

(52) U.S. Cl. 416/248

(57) ABSTRACT

Described herein is a novel and useful cross fluid-flow axis turbine (CFAT) that converts the energy of a flowing fluid to rotational energy. The invention includes an axle rotatably mounted on a frame. In one embodiment a plurality of arms extending outwardly from the axle. Each arm has at least one beam that supports at least one outer foil and an inner foil, the inner foil being positioned between the inner most outer foil and the axle.

The upper surfaces of the foils face toward the direction of rotation of the axle so that lift generated by the foils contributes to the rotation of the axle.

The foils are oriented and aligned so that fluid flowing into the turbine is redirected by the inner foils to the leading edge of the outer foils. The flow of fluid through the center of the turbine can be restricted by a baffle or by placing the inner edge of the inner foils sufficiently close to the axle.

The CFAT can be used as a wind turbine or a water turbine through simple modification of the frame and support structure.

### CROSS-REFERENCE TO PRIOR APPLICATIONS

This application claims the benefit of U.S. Provisional Patent Application No. 60/872,679, filed on Dec. 5, 2006.

### BACKGROUND OF THE INVENTION

1. Field of the Invention

The present invention relates to turbines and similar devices that are caused to rotate by a flowing fluid, and more particularly the invention relates to cross fluid-flow axis turbines.

2. Scope and Meaning of Certain Terms

The following lexicon sets forth the intended scope and meaning of certain terms and concepts used herein. Examples provided in this lexicon are intended to clarify and not to limit the meaning of the respective terms. The definitions set forth here include the plural and grammatical variations of the terms defined.

Fluid—is used generically to include both gases and liquids. Although the embodiments focus on the use of air and water to drive turbines according to the invention, these embodiments are not intended to preclude applications in which other fluids are employed.
Frame—is used broadly to mean any structure for supporting a turbine in a manner that permits the turbine to rotate freely.
Foil—is used in the commonly accepted aerodynamic sense to mean a structure capable of producing lift and having a cross-sectional profile of a wing; i.e., having a rounded leading edge, an opposing trailing edge, and a camber, wherein the thickness of the structure is greater at the leading edge than at the trailing edge. The term as used herein includes both foils that generate lift from flowing gases and foils that generate lift from flowing liquids. Unless otherwise specified, the use of the term is intended to include foils having symmetrical cross-sections as well as those having asymmetrical cross-sections.
Set of foils—refers to a group of at least two foils functionally related such that flowing fluid is directed by a first foil in the set towards a second foil in the set, thereby producing or augmenting lift produced by the second foil.
Upper and lower—these terms are used herein to describe the surfaces and cambers of a foil wherein “upper” refers to that surface or camber of the foil that faces the direction of lift, and “lower” refers to the opposing surface or camber. Thus, these terms are used here in the common and accepted parlance of aerodynamics, and in analogy with airplane wings. Unless otherwise indicated, these terms are not intended to denote or imply a vertical orientation, nor any particular orientation with respect to the ground or the sky.

3. Existing Art

Modern turbines are divided into two major categories: horizontal axis turbines (“HATs”) and cross fluid-flow axis turbines (“CFATs”).

Wind turbines of the HAT-type are commonly known and typically comprise a tower and a fan-like rotor mounted at the top of the tower. The traditional farm windmill is an example of a HAT. The fan rotates about an axis substantially parallel to the earth's surface. The rotor of a horizontal axis wind turbine must face either into or away from the direction of the wind and a yaw mechanism is required to rotate the rotor about the fluid flow axis of the tower to keep the rotor in proper alignment with the wind flow. Since a mechanical means of delivering power to the ground could cause the rotor to yaw out of alignment with the wind, energy conversion devices, such as generators, power transmission equipment, and related equipment are typically also mounted atop the tower. A structurally robust and costly tower is required to support the weight of the elevated equipment. In addition, the tower structure must resist oscillation and fatigue resulting from pressure pulsations produced by the interaction of the moving rotor blades and the tower. Likewise, the pressure pulse created by the wind shading of the tower causes the blades of the rotor to flex inducing fatigue in the blades and other rotor components. Maintenance of HATs can be complex because the equipment is located at the top of the tower. A large crane is typically required to replace equipment or to support the rotor during bearing replacement or maintenance. While HAT installations are relatively complex and expensive, they are the most common wind turbine configurations in current use.

CFATs comprise, generally, a central rotating axle oriented at right angles to the flow of the fluid, with a plurality of vanes attached to the axle. In the case of wind CFATs, the axle is generally vertical with respect to the ground and the foils are arrayed around the axle and roughly perpendicular to the wind flow. CFATs do not require a yaw mechanism to align the blades with the wind; consequently, the generator or other energy converter and related power transmission equipment may be mounted on the ground at the base of the turbine, substantially reducing the complexity and cost of the installation.

In a typical CFAT, the blades on one side of the turbine move downstream with the direction of fluid-flow, transmitting the fluid forces to the axle. However, this force is countered by the blades on the other side, which resist as they are moving upstream against the flow of fluid. The challenge in creating an efficient CFAT is to maximize the force on one side of the axis, and minimize the resistance from the fluid affecting the blades on the other side.

Wind CFATs are divided generally into lift- and drag-types. Drag-type, for example three-cup anemometers and Savonius wind turbines, are rotated by the force produced by the wind impinging on the exposed area of cups, buckets, or paddles arranged around a vertical axle. Savonius (U.S. Pat. No. 1,697,574) discloses a vertical axis wind turbine that can be described as a barrel cut in half lengthwise with the halves offset to form two scoops and mounted on a vertical axle. The efficiency of a Savonius turbine is limited because power produced by the gathering side of the rotor is offset by drag produced by the opposite side of the rotor. In addition, since the area of the scoops exposed to the wind flow varies as the turbine rotates, the torque is not evenly distributed throughout a revolution of the axle, and no torque is produced to initiate rotation if the rotor is improperly aligned with the wind flow. While this type of turbine can produce high torque and can be useful for pumping water and similar tasks, the speed of rotation is generally too slow for efficient production of electricity, a major use of commercial wind turbines.

Lift-type wind CFATs rely on the lift force generated as the wind flows over a foil to obtain tip speeds exceeding the wind's velocity. Darrieus (U.S. Pat. No. 1,835,018) discloses a typical wind CFAT. The Darrieus wind turbine may comprise C-shaped strap-like rotor blades attached at their top and bottom ends to a vertical central axle or rectilinear blades arranged parallel to the axle in a cylindrical drum or squirrel cage arrangement (sometimes referred to as a “Giromill”). Since lift forces provide the torque for rotation, the tip speed of the blades can exceed the speed of the wind. Darrieus wind turbines can have a tip speed/wind speed ratio exceeding 3, making this type of turbine suitable for electric power generation.

The wind turbine of Ursa (U.S. Pat. No. 7,083,382) employs rotating foils having a wing-type design. The wings are able to rotate about an axis that is near the leading edge so that when moving downstream in the direction of the wind flow during the rotation of the turbine, the wings present a flat surface against which the wind pushes, but when moving upstream against the direction of the wind flow, the wings generate lift as a result of unequal pressures on the upper and lower surfaces of the wings. Consequently, Ursa, like the present invention, exploits foils throughout the rotational cycle, but Ursa does so in a complex way that requires a large number of foils to be spinning simultaneously and creating very significant noise. The present invention is a quieter, more efficient way to employ foils in a CFAT.

What is desired, therefore, is a turbine combining the lower cost and reduced complexity of a CFAT with the higher efficiency, self-starting capabilities, and performance of a HAT.

### BRIEF SUMMARY OF THE INVENTION

My invention is a novel water/wind CFAT for converting the energy of a flowing fluid to rotational energy. The invention comprises a turbine comprising a plurality of foils. The turbine is mounted on or in a frame.

In the wind embodiment, the frame may be a stand alone frame anchored to the ground or placed on top of a building or other supporting structure. The frame is open so that wind from any direction has access to the turbine.

In hydraulic applications of the invention, the turbine of the CFAT can be housed in a completely submerged structure in a river or tidal area, or it can be housed below a floating structure such as a catamaran. A weir or mesh barrier protects the turbine from debris from entering the turbine.

In both embodiments an electrical generator or gearbox may be connected to or incorporated in the turbine to harness its rotational energy. Rotational energy can also be mechanically transmitted to generators or machinery by means of a mechanical connection between the turbine and a generator or other device.

The turbine comprises a support element attached to a central axle, which axle is rotatably mounted in or on the frame to rotate about an axis of rotation in a direction of rotation. In one preferred embodiment, the support element comprises 4 arms that are oriented at substantially right angles from each other, thereby describing four quadrants lying within a circle of rotation circumscribed by the rotation of the tips of the arms.

Each arm comprises at least one support beam adapted to support at least two foils. Each foil has a rounded leading edge, a sharp trailing edge, and a long axis at right angles to the chord of the foil. Each arm has at least one outer foil and an inner foil, the inner foil being positioned on the support beam between the outer foil or foils and the axle.

Each foil is optionally supported by the support beams such that the long axis of the foil is substantially parallel to the axis of rotation of the axle and perpendicular to the support beam. The term “long axis” is used herein to refer to that axis of the foil that is parallel to the leading edge. The term “long axis” is not intended to restrict the relative dimensions of the foils. In addition, foils that are neither square nor rectangular when viewed from one of the flat surfaces may be employed, for instance foils having the shape of an irregular polygon. In such instances the leading edge of the foil may be oriented at an angle to the axle.

The support beams are generally elongate having a proximal end and a distal end. The proximal end of each beam is connected to the axle so that the beam extends outward from the axle. Rectilinear forces produced by the flowing fluid impinging on the foils are transmitted through the support elements to the axle as rotational energy.

Alternative foil support means may be employed. For example, the beams may be replaced with upper and lower disks that are concentric with the axle and upon which the foils are mounted. Other means for supporting the foils and connecting them to the axle will be apparent to those skilled in the art after having read this disclosure.

The chord of each foil divides the foil into an upper camber and lower camber, the upper camber being bounded by an upper surface and the lower camber being bounded by a lower surface. The foils are oriented such that the upper surface of each foil faces the direction of rotation of the turbine. In the preferred embodiment the camber of the foils is asymmetrical, but symmetrical cambers can be used depending on the preferred angle of attack of the foil.

In the preferred embodiment the foils are substantially identical to one another in size and shape. However, the scope of the invention is not limited to identical foils. After reading and comprehending the disclosures made herein, those with skill in the art may, without undue experimentation, find that a mixture of diverse shapes, sizes, and orientations of foils produce usable results.

Each quadrant of the turbine, as defined by the four arms, has fluid flowing into and through it such that at each point in the rotation cycle of the axle, each foil either contributes to the force of rotation, or is neutral. The fluid movement within the turbine creates a centrifugal motion that drives the fluid toward the outside of the turbine, over the foils. This causes lift at each of the foils, which produces significant efficiencies and contributes to the ability of the turbine to self-start.

Further efficiency is added as the fluid flowing over the inner foils is directed toward leading edge of the outer foils. In this way, the air is continually directed toward the outer array of foils, which foils produce greater torque as a result of being located further from the axis. The design goal of maximizing torque rather than speed of rotation creates benefits as power is created by increased torque. A slower speed of rotation minimizes noise, maintenance due to slower moving parts, and environmental impact.

Efficiency is enhanced by orienting the foils with optimum spacing and rotation within the turbine to maximize the lift created by the foils as the turbine rotates. The optimal foil will have a design that is unique to its turbine within the constraints of having two or more foils per arm. The diameter of the turbine and the anticipated fluid speed are the major determinants of the number and size of foils employed. It is most desirable that the foils are capable to produce lift as fluid passes over the upper surface of the foil in either direction; i.e., from the leading edge toward the trailing edge, as in a traditional wing, but also from the trailing edge to the leading edge.

The simplicity and lack of moving parts within the turbine structure create the ability for modular design. Individual foil assemblies can be stacked to provide increased height. To increase the diameter, the arms can be extended and additional foils installed. During periods of high wind velocity, the length of the arms and the number of foils can be easily reduced.

Optionally, the turbine is provided with braking and locking mechanisms to stop the turbine from rotating when a flowing fluid is present and to prevent the turbine from rotating once it is stopped.

### BRIEF DESCRIPTION OF THE DRAWINGS

In the drawings identical reference numbers are employed to identify identical elements. The sizes and relative positions of the elements in the drawings are not necessarily to scale. For example, thicknesses are generally not drawn to scale and are enlarged to insure comprehension of the drawings.

FIG. 1 is a perspective view of one preferred embodiment of the invention used as a wind CFAT in which the foils support means is a plurality of beams.

FIG. 2 is a perspective view of the invention employed as a water CFAT

FIGS. 3A and 3B are representational cross-sections of the turbine of the invention showing two options for positioning the foils on the support beams.

FIG. 4 is a perspective view of one preferred embodiment of the invention in which the foils support means is a pair of disks.

### DETAILED DESCRIPTION OF THE INVENTION

The inventive concepts and novel features of the invention are described here with reference to a specific application of preferred embodiments of the invention. These embodiments represent the best mode known to me for practicing the invention. Although the steps and elements of the invention, as well as their structural and functional relationships, are disclosed with respect to the preferred embodiments, it is to be noted that these disclosures are representative of many possible embodiments that incorporate the inventive concepts of our invention. Disclosures of the invention are intended to be for illustrative purposes, and are not intended to limit the scope of the invention to any particular application.

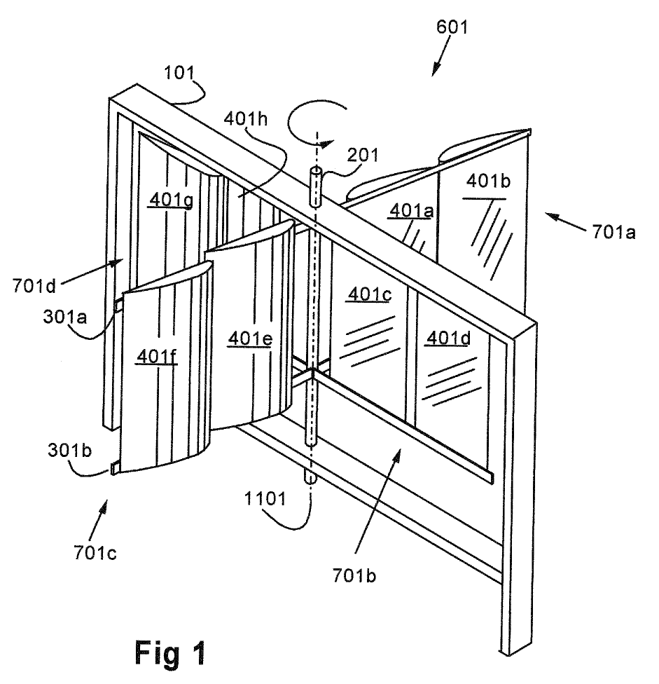

FIG. 1 illustrates an embodiment of the invention used as a wind CFAT, wherein the fluid flowing through the turbine is a gas, and more particularly, air. A frame is shown 101, upon which is rotatably mounted turbine 601. The frame may be self-supporting and free-standing. The frame is open on all sides to allow wind to impinge upon the turbine regardless of the wind's direction. The material of which the frame is constructed is not critical. A steel frame is preferred because it affords sufficient strength to resist the forces imparted by the foils and rotation of the turbine in high winds.

The turbine includes an axle 201, which is co-existent with an axis of rotation 1101 of the turbine. The axle is rotatably mounted to the frame by means—such as bearings and bushings (not shown)—and in a manner well known in the art to produce the minimum frictional drag on the rotation of the axle. A portion of the axle extends beyond the frame so that the axle can be connected to a generator or other device capable of harnessing the rotational energy of the axle.

The turbine also includes a plurality of arms 701a-d extending from and connected to axle 201. Each arm comprises a pair of support beams, such as 301a, 301b shown on arm 701c. The support beams are connected to axle 201 either directly or indirectly through a connecting device. The material of which the beams is constructed is not critical, but metal is preferred to provide the necessary strength.

Each arm comprises a set of foils 401a-401h supported by the support beams. In the preferred embodiment, each pair of support beams supports a set of two rectangular foils oriented such that their long axes are oriented substantially parallel to the axle. Arm 701, for example, is thusly made up of two support beams 301a, 301b connected to the axle 201 and two foils 401e, 401f supported by the support beams. The foils may be constructed from any suitable material such as sheet metal, plastic, foam, or rubber. Hollow foils with inner support struts are preferred because they promote a lower surface area to weight ratio. Designs and methods for producing such foils are well known in the arts of aerodynamics and hydrodynamics. Depending on the number and materials of the foils, in some embodiments of the invention it is possible to achieve good results by having only one support beam supporting the foils of a given arm. In circumstances of very forceful flowing fluids it may be necessary or desirable to have more than two support beams.

As will be appreciated from FIG. 1, one of the subtle advantages of my invention is that, unlike many existing CFATs, my invention presents a solid surface when viewed from all angles. This greatly mitigates the very common problem of birds flying into the spinning turbine.

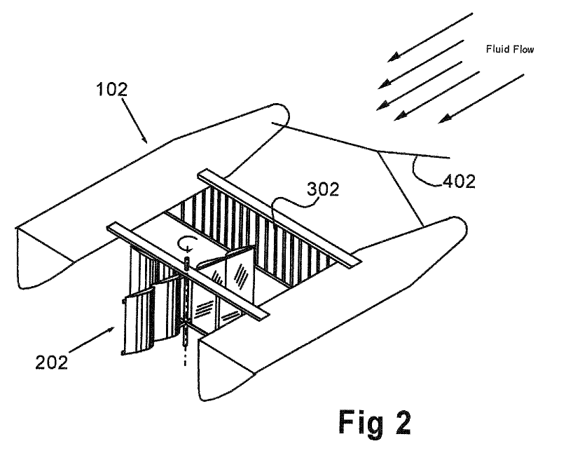

FIG. 2 illustrates how the same general structure of FIG. 1 is scaled and adapted to be used as a water CFAT, which is to say the CFAT is adapted to be water-borne or submersible in a flowing liquid.

The frame in the hydraulic embodiment can be a floating structure such as catamaran 102. The turbine 202 is supported by and suspended below the catamaran, which is tethered or anchored facing upstream. Optionally, a weir 302 is provided to prevent fish, seaweed, or floating debris from becoming ensnared in the turbine. In tidal environments the floating frame is anchored or moored by a central anchor or mooring line 402 so as to be constantly aligned with the tidal flow. When used in a river or stream, the platform is more conveniently tethered to each bank with a pulley system (not shown) to provide for easy retrieval of the device. The invention is also easily adapted such that the frame is submersible, in which case the invention can be submerged to any depth, including being fixed to the bottom of a river, stream, or tidal area.

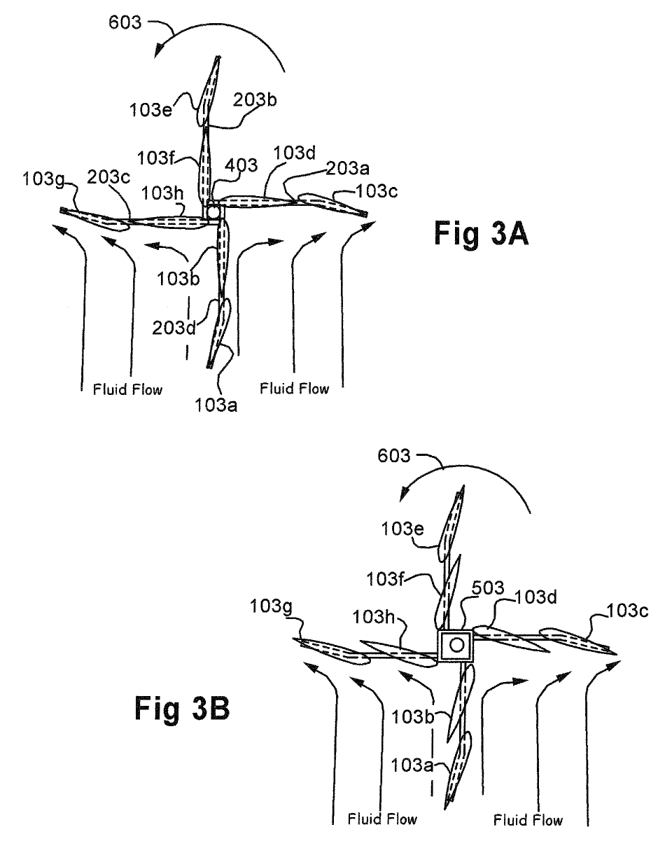

FIGS. 3A and 3B illustrate in more detail two preferred orientations of the foils used to achieve optimal results. It is emphasized that the precise orientations of the foils will vary depending upon the individual requirements and the conditions. We set forth here two examples that can be used to guide users of the invention to practice and apply the invention in a wide variety of circumstances and environments without undue experimentation. FIGS. 3A and 3B represent a view from above wherein the frame and the upper support beams are removed to enhance the clarity of the description.

FIG. 3A shows what is referred to herein as a “closed configuration.” Lower support beams 203a-203d extend from and are connected to axle 403 by means of a support beam proximal end. Each beam supports a set of two of foils 103a-103g. Foils 103a, 103c, 103, 103g form a course of outer foils. Foils 103b, 103d, 103f, 103h form a course of inner foils positioned between the inner-most outer foils and the axle. The term “inner” and “outer” is used to denote direction along the arms with respect to axle 403. Arrow 603 indicates the direction of rotation of the turbine, which is counter clockwise in this example. The fluid flow is also indicated.

In FIG. 3A it can be seen that the leading edges of all of the foils are facing toward the center of the turbine; the trailing edges point outwards. The upper surfaces of the foils face the direction of rotation. The inner foils 103b, 103d, 103f, 103h are oriented such that their chords are substantially parallel to the support beams and at right angles to the axle. The leading edges of the inner foils are sufficiently close to the axle to substantially restrict flow of fluid through the central portion of the turbine and around and past the axle. The outer foils 103a, 103c, 103e, 103g are oriented such that the chord of each outer foil is rotated with respect to the chord of its respective inner foil. For example outer foil 103a is rotated with respect to inner foil 103b such that their chords intersect at an angle of about 27 degrees. This can be achieved by having the foils mounted in a pivotal manner on their support beams, or by having the support beam bent to provide the proper angle, as is shown in FIGS. 3A and 3B.

In one preferred embodiment, the inner foils and/or the outer foils can be rotated about their long axis and secured in a preferred orientation in order to produce differing angles between the foils. This allows the turbine to be quickly and easily fine-tuned to meet environmental and meteorological vicissitudes. Pins are used to fix the inner foils in their desired orientations.

As a result of such of the foil orientations, fluid entering the central portion of the turbine is redirected by an inner foils in a set to flow to the leading edge of the outer foil in the set, thereby producing or augmenting the lift by the outer foils, which are positioned on the support beams so as to maximize the torque produced by the lift. The forces from the foils are transmitted to the axle by the support beams.

Referring again to FIG. 3A, assume that a fluid such as air is flowing into the turbine from some arbitrary direction, say from the bottom of the figure; i.e., the 6 o'clock position, as indicated in the figure. As the fluid enters the lower left hand quadrant, it is redirected by inner foil 103h toward the leading edge of outer foil 103g, thereby generating lift in the counter-clockwise direction. The flowing fluid also impinges on the lower surfaces of foils 103c and 103d and is redirected outward by those foils toward the perimeter of the turbine. As the wind moves away from the axle, foils 103c and 103d also produce lift and torque; consequently, an additional force in the counter-clockwise direction is produced. As to foils 103a and 103b, there is a lift produced in the direction of rotation by the fluid flowing “backwards” over the upper surface of the foils. Lee foils 103e and 103f are not affected by the fluid flowing from the bottom because they are in the shadow of foils 103a, 103b, 103g, 103h; consequently, they are neutral with respect to producing any rotational force.

The net result of these forces is that support beams of three of the arms transmit to axle 403 a rotational force in the counter-clockwise direction, and the fourth arm produces no rotational force at all. As the turbine turns, these forces shift to succeeding arms as the arms pass through the fluid flow, but the net direction of the forces remains in the counter-clockwise direction.

As noted above, the leading edges of the inner foils in FIG. 3A are sufficiently close to axle 403 to substantially block air flow through the center of the turbine. By restricting fluid flow through the center of the turbine, either by employing a central baffle or by employing the closed configuration, the turbine becomes self-starting. Optionally, one may employ a starter device, such as an electric motor, to initiate the rotational cycle, but the self-starting embodiment is preferred because it requires a minimum of attention.

FIG. 3B shows an open configuration of the foils in which inner foils 103b, 103d, 103f, 103h are set further back from axle 403. The inner foils are also rotated about their long axis so that the chord of each foil is substantially parallel to the chord of the outer foil on the same arm. The advantage of this configuration is that the further away the foils are from the axle, the more torque is generated from the same amount of fluid flow.

In some situations it is desirable when using the open configuration to include a central baffle to prevent excessive fluid flow through the volume surrounding the axle. As noted above, restricting the central flow contributes to the turbine's ability to self-start. This baffle can be, for instance, an elongate box 503 or tube surrounding the axle.

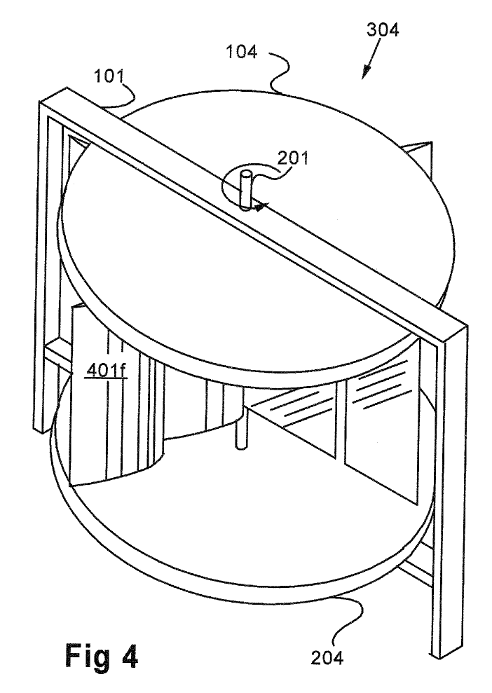

FIG. 4 illustrates a preferred embodiment similar to that shown in FIG. 1, but in which the support element for supporting the foils comprises at least one upper disk 104, and preferably, a second, lower disk 204, the disks being concentric with the axle 201 and connected to the axle to produce a drum or can-type turbine 304 wherein force is transmitted from the foils, such as 401f, through the disks to the axle.

Those of skill in the art, upon reading the disclosures made herein, will recognize that there are numerous types of support means for supporting the foils that are within the scope of the disclosure and claims.

Optional configurations embody multiple turbines mounted in a single same frame, at least two of the turbines rotate in opposite directions due to the judicious choice of orientation of the foils. Such counter-rotating turbines provide many benefits by reducing the torque on the overall structure, which makes this configuration particularly beneficial for water borne installations. Airborne turbines that are suspended by lift, and are tethered to the ground would be another suitable application for this configuration.

### SUMMARY

From the foregoing description and figures, the novelty, utility, and means of using and making the invention will be readily apprehended. It is to be understood that the invention is not limited to the embodiments disclosed above but encompasses any and all embodiments lying within the scope of the following claims. The metes and bounds of our invention are to be ascertained by referring to the claims in conjunction with the figures and the foregoing disclosures.

I claim:

1. A cross fluid-flow axis turbine (CFAT) for converting the energy of a flowing fluid to rotational energy, said CFAT being of the type having an axle rotatably mounted on a frame so that the axle rotates about an axis of rotation in a direction of rotation, said CFAT comprising:
a. at least three sets of foils, each set comprising an inner foil and at least one outer foil; and,
b. a support means for supporting said sets of foils, said support means connected to the axle, wherein for each of said sets of foils said inner foil is supported on or by said support means between the axle and said outer foil, and wherein lift forces generated by said inner foil and said outer foil are transmitted to the axle through said support means; and wherein said inner foil and said outer foil are oriented such that the flowing fluid is redirected by said inner foil toward said outer foil such that lift is produced in the direction of rotation, whereby the axle is caused to rotate in the direction of rotation.

2. The CFAT of claim 1 wherein said support means comprises a plurality of beams extending outwardly from the axle.

3. The CFAT of claim 1 wherein said support means comprises at least one disk.

4. The CFAT of claim 1 wherein said inner foil and said outer foil are oriented so that their long axes are substantially parallel with the axle.

5. The CFAT of claim 1 wherein the flowing fluid is a gas.

6. The CFAT of claim 5 wherein the gas is air.

7. The CFAT of claim 1 wherein the CFAT is adapted to be water-borne or submerged.

8. The CFAT of claim 7 wherein the flowing fluid is a liquid.

9. The CFAT of claim 8 wherein the liquid is water.

10. The CFAT of claim 1 wherein the flowing fluid is directed by said inner foil to flow to the leading edge of said outer foil.

11. The CFAT of claim 1 further comprising a means for restricting the flow of fluid through the center of said CFAT.

12. The CFAT of claim 11 wherein said means for restricting the flow of fluid through the center of said CFAT comprises a baffle.

13. The CFAT of claim 11 wherein said means for restricting the flow of the fluid through the center of said CFAT comprises the inner most edges of said inner foil being positioned sufficiently close to the axle to substantially restrict flow of the fluid past the axle.

14. The CFAT of claim 1 wherein at least one of said inner foil and said outer foil can be rotated about its long axis and secured in that orientation in order to produce differing angles between the chords of said inner foil and said outer foil.
